(19) United States
(12) Patent Application Publication
(10) Pub. No.: US 2013/0263977 A1
(43) Pub. Date: Oct. 10, 2013

(54) METHOD FOR MANUFACTURING COMPONENTS OR COUPONS MADE OF A HIGH TEMPERATURE SUPERALLOY

(71) Applicant: ALSTOM Technology Ltd, (US)

(72) Inventors: Lukas Rickenbacher, Basel (CH); Thomas Etter, Muhen (CH)

(73) Assignee: ALSTOM TECHNOLOGY LTD, Baden (CH)

(21) Appl. No.: 13/664,604

(22) Filed: Oct. 31, 2012

(30) Foreign Application Priority Data
Oct. 31, 2011 (CH) 01754/11

(51) Int. Cl. B23K 26/34; B05D 3/06

(52) U.S. Cl. CPC B23K 26/345; B05D 3/06
USPC 148/540; 164/492; 148/555; 148/538; 164/494

(57) ABSTRACT

A method for manufacturing a component or coupon made of a high temperature superalloy based on Ni, Co, Fe or combinations thereof includes forming the component or coupon using a powder-based additive manufacturing process. The manufacturing process includes completely melting the powder followed by solidifying the powder. The formed component or coupon is subjected to a heat treatment so as to optimize specific material properties. The heat treatment takes place at higher temperatures compared to cast components or coupons.

### CROSS REFERENCE TO RELATED APPLICATIONS

This application claims priority to Swiss Patent Application No. CH 01754/11, filed Oct. 31, 2011, which is hereby incorporated by reference herein in its entirety.

### FIELD

The present invention relates to the technology of superalloys, and specifically relates to a method for manufacturing components or coupons made of a high temperature superalloy.

### BACKGROUND

The influence of various heat treatments on an exemplary Ni-based and cast superalloy like IN738LC has been investigated in the past.

Durability of this superalloy is dependent on the strengthening of γ′ precipitates (see for example E. Balikci et al. Influence of various heat treatments on the microstructure of polycrystalline IN738LC, Metallurgical and Materials Transactions A Vol. 28, No. 10, 1993-2003, October 1997). The 1120° C./2 h/accelerated air-cooled (AAC) solution treatment, given in the literature, already produces a bimodal precipitate microstructure, which is, thus, not an adequate solutionizing procedure to yield a single-phase solid solution in the alloy at the outset. A microstructure with fine precipitates develops if solutionizing is carried out under 1200° C./4 h/AAC conditions. Agings at lower temperatures after 1200° C./4 h/AAC or 1250° C./4 h/AAC or WQ conditions yield analogous microstructures. Agings below 950° C. for 24 hours yield nearly spheroidal precipitates, and single aging for 24 hours at 1050° C. or 1120° C. produces cuboidal precipitates.

Two different γ′ precipitate growth processes are observed: merging of smaller precipitates to produce larger ones (in duplex precipitate-size microstructures) and growth through solute absorption from the matrix.

However, a superalloy of this kind, which is manufactured by a powder-based additive manufacturing process, behaves different with regard to its mechanical properties due to a different microstructure.

### SUMMARY OF THE INVENTION

In an embodiment, the present invention provides a method for manufacturing a component or coupon made of a high temperature superalloy based on Ni, Co, Fe or combinations thereof includes forming the component or coupon using a powder-based additive manufacturing process. The manufacturing process includes completely melting the powder followed by solidifying the powder. The formed component or coupon is subjected to a heat treatment so as to optimize specific material properties. The heat treatment takes place at higher temperatures compared to cast components or coupons.

### BRIEF DESCRIPTION OF THE DRAWINGS

Exemplary embodiments of the present invention are described in more detail below with reference to the drawings, in which:

FIG. 1 shows the result of an Electron Microprobe Analysis (EPMA) of an IN738LC specimen processed by Selective Laser Melting (SLM) at room temperature (RT);

FIG. 2 shows the corresponding result of an Electron Microprobe Analysis (EPMA) of a reference IN738LC specimen that has been cast in the usual way;

FIG. 3 shows the schematic ° C.(t) curve of a “reference” heat treatment of an SLM IN738LC specimen (FIG. 3(a)) and the resulting microstructure at 500 nm scale and 200 nm scale (FIG. 3(b), left and right picture);

FIG. 4 shows the schematic ° C.(t) curve of a heat treatment modified according to the invention of an SLM IN738LC specimen (FIG. 4(a)) and the resulting microstructure at 500 nm scale and 200 nm scale (FIG. 4(b), left and right picture);

FIG. 5-8 show the schematic ° C.(t) curves of four different heat treatment cycles according to the invention that have been used to treat four similar samples of an SLM IN738LC alloy;

FIG. 9 shows the microstructure of the sample treated according to the ° C.(t) curve of FIG. 5 at 2 mm and 500 μm resolution;

FIG. 10 shows the microstructure of the sample treated according to the ° C.(t) curve of FIG. 6 at 2 mm and 500 μm resolution;

FIG. 11 shows the microstructure of the sample treated according to the ° C.(t) curve of FIG. 7 at 500 μm and 200 μm resolution;

FIG. 12 shows the microstructure of the sample treated according to the ° C.(t) curve of FIG. 8 at 500 μm and 200 μm resolution;

FIG. 13 shows in comparison the microstructure of the sample treated according to the ° C.(t) curve of FIG. 6 at 500 μm and 200 μm resolution (lower left and right picture) and the microstructure of the sample treated according to the reference tratment of FIG. 3 at 500 μm and 200 μm resolution (upper left and right picture); and

FIG. 14 shows process steps of a partial heat treatment according to the invention to modify the properties of a component (turbine blade) in a specified region of said component.

### DETAILED DESCRIPTION

An aspect of the present invention to provide a method for manufacturing a component or coupon, i.e. a part of a component, made of a high temperature superalloy based on Ni or Co or Fe or combinations thereof by means of a powder-based additive manufacturing process, which is optimized with regard to achieving tailor-made mechanical properties.

In an embodiment, the method comprises the steps of
a) forming said component or coupon by means of a powder-based additive manufacturing process, wherein during said process the powder is completely melted and afterwards solidified; and
b) subjecting said formed component or coupon a heat treatment to optimize specific material properties; whereby
c) said heat treatment takes place at higher temperatures compared to cast components or coupons.

Said heat treatment improves specific material properties such as creep strength, low cycle fatigue behavior, etc., by optimizing said microstructure.

The invention thus relates to the heat treatment of materials/components/coupons made of Ni/Co/Fe-based superalloys produced by a powder-based additive manufacturing technology, such as SLM (Selective Laser Melting) or LMF (Laser Metal Forming) or EBM (Electron Beam Melting). These articles have different microstructures compared to conventionally cast material of the same alloy, for instance. This is primarily due to powder based article production and the inherent high cooling rates of the energy beam-material interaction in these processes. As a consequence, the material is very homogeneous with respect to chemical composition and principally free of segregations.

Due to the fact that Ni/Co/Fe-based superalloys produced by powder-based additive manufacturing technologies are generally free of residual eutectic contents, heat treatments at higher temperatures compared to cast components/coupons can be realized to achieve a higher solution degree without the risk of incipient melting. This allows an adjustment of the microstructure over a wide range, including grain size and precipitation optimization, leading to improved material properties. Furthermore, this allows tailoring the material properties to its specific application, which is very limited with conventional manufacturing methods such as casting. This can be used for modular part concept, where each segment are optimized according to their function, e.g. leading edges having improved LCF behaviour whereas thermally loaded areas having an increased creep strength.

Said high temperature material may be a Ni-based alloy, such as, but not limited to those known under their brand names Waspaloy, Hastelloy X, IN617, IN718, IN625, Mar-M247, IN100, IN738, IN792, Mar-M200, 81900, RENE 80, Alloy 713, Haynes 230, Haynes 282, and other derivatives.

Said high temperature material may, on the other hand, be a Co-based alloy, such as, but not limited to those known under their brand names FSX 414, X-40, X-45, MAR-M 509 or MAR-M 302.

Said high temperature material may be a Fe-based alloy, such as, but not limited to those known under their brand names A 286, Alloy 800 H, N 155, S 590, Alloy 802, Incoloy MA 956, Incoloy MA 957 or PM 2000.

Or, said high temperature material may be a superalloy based on more then one selected from the group of Fe, Ni, Co.

According to an embodiment of the invention said powder-based additive manufacturing process is one of Selective Laser Melting (SLM), Selective Laser Sintering (SLS) or Electron Beam Melting (EBM) comprising the following steps:
d) generating a three-dimensional model of said component or coupon;
e) calculating cross sections of said model by means of a slicing process;
f) providing an additive manufacturing machine with a machine control unit;
g) preparing the powders of said Ni or Co or Fe based superalloy, which are needed for the process,
h) passing to and storing in said machine control unit said calculated cross sections;
i) preparing a powder layer with a regular and uniform thickness on a substrate plate of said additive manufacturing machine or on a previously processed powder layer;
j) performing melting of said powder layer by scanning with an energy beam according to a cross section of said component stored in said control unit;
k) lowering the upper surface of the so formed cross section by one layer thickness; and
l) repeating steps f) to h) until reaching the last cross section of said three-dimensional model.

According to another embodiment of the invention a particle size distribution of said powder is adjusted to said layer thickness to achieve a good flowability, which is required for preparing powder layers with regular and uniform thickness.

According to another embodiment of the invention said powder consists of particles having a spherical shape.

Especially, the required particle size distribution of the powder is obtained by sieving and/or winnowing (air separation).

According to a further embodiment of the invention the powder or powders is (are) obtained by one of gas or water atomization, plasma-rotating-electrode process, mechanical milling or like powder-metallurgical processes.

According to another embodiment of the invention said powder-based additive manufacturing process is one of Laser Metal Forming (LMF), Laser Engineered Net Shape (LENS) or Direct Metal Deposition (DMD), and may use material in form of a wire instead of powder.

According to another embodiment of the invention a suspension is used instead of powder.

According to just another embodiment of the invention said superalloy comprises fine dispersed oxides, especially Y₂O₃, AlO₃ or ThO₂.

According to another embodiment of the invention said heat treatment is done in an equipment, which is used for forming said component or coupon.

Alternatively, said heat treatment may be done in an equipment, which is different from a component or coupon forming equipment.

According to a further embodiment of the invention said heat treatment is a combination of different individual heat treatments.

According to a different embodiment of the invention only part of said component or coupon is subjected to said heat treatment.

According to another embodiment of the invention said heat treatment comprises multiple steps, each such step representing a specific combination of heating rate, hold temperature, hold time and cooling rate.

Before and/or after each heat treatment step said component or coupon may be subjected to various other processing steps such as, but not limited to, machining, welding or brazing, to use the specific advantages of a specific microstructure, e.g. small grains, which are beneficial for welding.

Furthermore, at least one of said heat treatment steps may be conducted at a sufficient high temperature and for a hold time long enough to partially or completely dissolve certain constituents in a microstructure of said component or coupon, such as intermetallic phases, carbides or nitrides.

According to another embodiment of the invention at least one of said heat treatment steps is conducted at a sufficient high temperature and for a hold time long enough to coarsen grains being present within said component or coupon.

Said grain coarsening results in microstructure comparable to a conventionally cast, directionally solidified or single crystal microstructure known from casting.

Especially, prior to said grain coarsening, said component or coupon may be deformed or specifically positioned in a powder bed and scanned with a specific hatching strategy to introduce residual stresses leading to anisotropic grain elongation in said corresponding heat treatment step.

According to a further embodiment of the invention at least one of said heat treatment steps is conducted at a sufficient high temperature and for a hold time long enough to precipitate metal-carbides, metal-nitrides or metal-carbonitrides, such as but not limited to, M(C,N), M₆C, M₇C₃ or M₂₃C₆ (M being a metal).

Furthermore, at least one of said heat treatment steps may be conducted at a sufficient high temperature and for a hold time long enough to precipitate intermetallic phases such as, but not limited to, Ni₃(Al,Ti), known as gamma-prime, or Ni₃(Nb,Al,Ti), known as gamma-double-prime, or Ni₃Nb, known as delta-phase.

Especially, at least one of said heat treatment steps may be conducted at a sufficient high temperature and for a hold time long enough to precipitate metal-borides such as, but not limited to, M₃B₂, (M being a metal), to improve grain boundary strength.

At least one of said heat treatment steps is advantageously conducted at a sufficient high temperature and for a hold time long enough to modify the volume fraction, size, shape and distribution of said precipitations.

According to just another embodiment of the invention at least one of said heat treatment steps is conducted additionally under isostatic pressure, known as Hot Isostatic Pressing HIP, to further improve a microstructure of said component or coupon.

Due to the fact that Ni/Co/Fe-based superalloys produced by powder-based additive manufacturing technologies are generally free of residual eutectic contents, heat treatments at higher temperatures compared to cast components/coupons can be realized to achieve a higher solution degree without the risk of incipient melting. This allows specially adjusted heat treatments to optimize specific material properties, such as creep strength or low cycle fatigue behaviour, in a very broad spectrum, not achievable up to the present day. This is beneficial for modular part concepts as well as for reconditioning with a coupon repair approach, where material properties tailored for specific locations/applications are requested.

Therefore, this disclosure includes the manufacturing of three-dimensional articles by powder-based additive manufacturing technologies consisting of a high temperature material followed by a specially adapted heat treatment resulting in an optimized microstructure and therefore increased material properties.

Said powder-based additive manufacturing technology may be Selective Laser Melting (SLM), Selective Laser Sintering (SLS), Electron Beam Melting (EBM), Laser Metal Forming (LMF), Laser Engineered Net Shape (LENS), Direct Metal Deposition (DMD), or like processes. During said process the powder is completely melted and afterwards solidified.

Said high temperature material may be a Ni-based alloy, such as, but not limited to Waspaloy, Hastelloy X, IN617, IN718, IN625, Mar-M247, IN100, IN738, IN792, Mar-M200, 81900, RENE 80, Alloy 713, Haynes 230, Haynes 282 and other derivatives.

Alternatively, said high temperature material may be a Co-based alloy, such as, but not limited to FSX 414, X-40, X-45, MAR-M 509 or MAR-M 302.

Alternatively, said high temperature material may be a Fe-based alloy, such as, but not limited to A 286, Alloy 800 H, N 155, S 590, Alloy 802, Incoloy MA 956, Incoloy MA 957 or PM 2000.

Alternatively, said high temperature material may be a superalloy based on combinations of at least two selected from the group of Fe, Ni, Co.

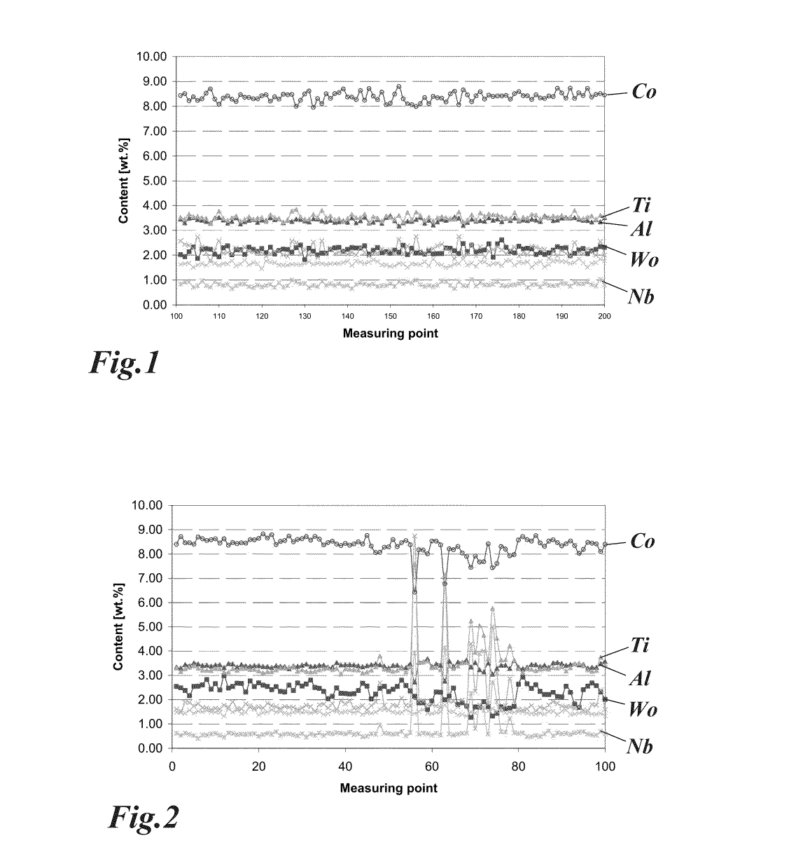

Embodiments of the invention will be explained in detail with regard to an IN738LC alloy (LC means Low Carbon). FIG. 1 shows the result of an Electron Microprobe Analysis (EPMA) of an IN738LC specimen processed by Selective Laser Melting (SLM) at room temperature (RT) (only some of the various elements of the alloy are labeled). For comparison, FIG. 2 shows the corresponding result of an Electron Microprobe Analysis (EPMA) of a reference IN738LC specimen that has been cast in the usual way. It is obvious by comparing FIG. 1 and FIG. 2 that the scattering/variation in the SLM specimen is substantially lower compared to the “cast reference”, although no significant difference of the mean value can be seen between the SLM and the cast specimen. Especially, no significant depletion of γ′-formers such as Al and Ti occurred during processing of the SLM specimen.

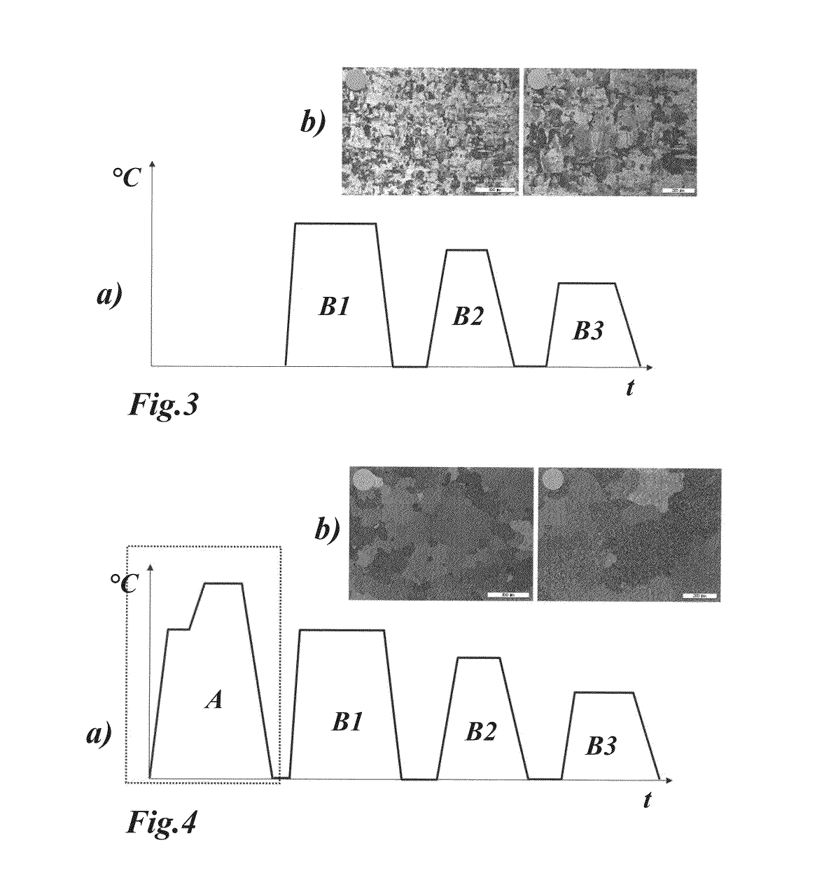

According to an embodiment of the invention, such an SLM IN738LC specimen has been subjected to a heat treatment (FIG. 4(a)), which is a modification of the usual heat treatment (FIG. 3(a)), the modification comprising an initial high-temperature Solution Heat Treatment (SHT) step A, which is followed by three other (usual) heat treatment steps B1-B3 at lower temperatures.

As can be seen from the respective pictures of the microstructure (FIGS. 3(b) and 4(b)), said modified heat treatment changes and optimizes the microstructure, thereby improving specific material properties such as creep strength, LCF behavior etc. Especially, a significant grain coarsening takes place as a result of a modified heat treatment.

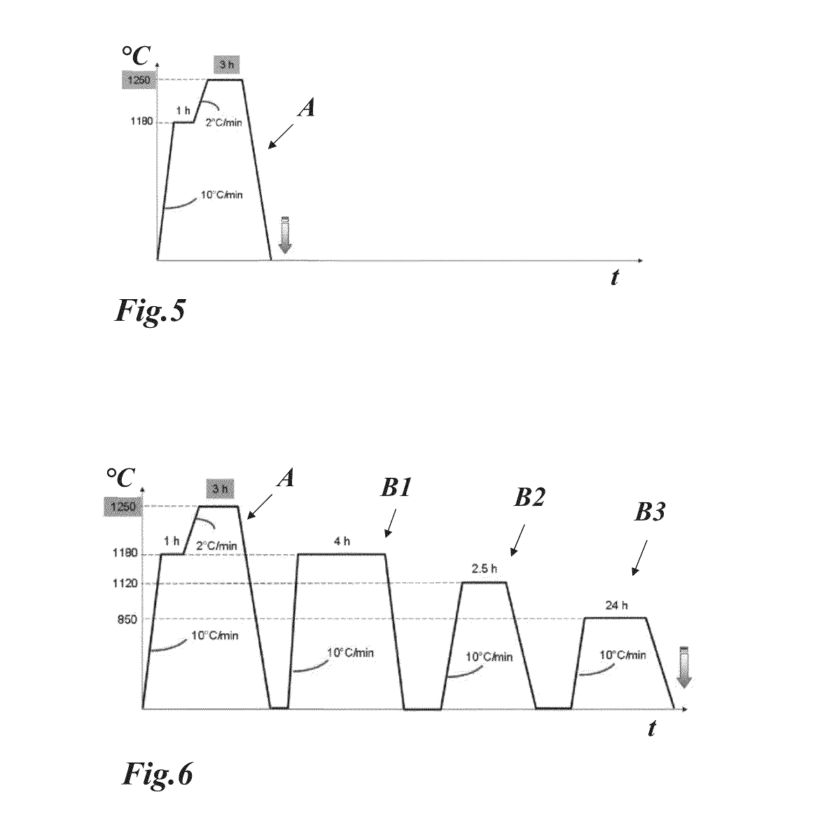

To investigate the influence of the solution temperature and hold time on the grain size, four different samples of an IN738LC material were subjected to different heat treatments as shown in FIG. 5-8. The heat treatment trials were done on small rectangular test pieces. It is important to note that the heat treatment trials were done in the “as-built” condition, e.g. without previous heat treatments (e.g. no Hot Isostatic Pressing treatment).

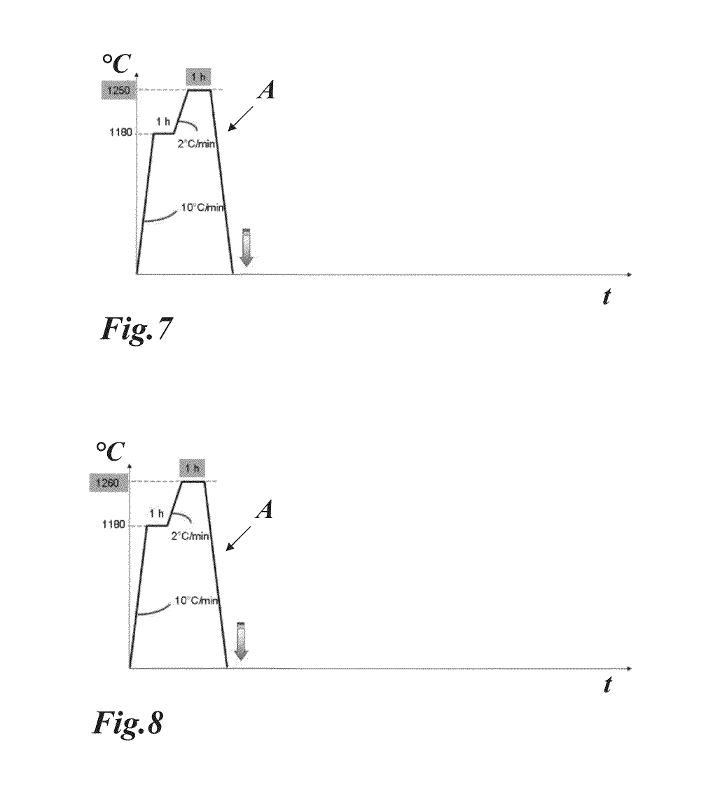

The treatments were as follows:
First sample: 1250° C./3 h (FIG. 5)
Second sample: 1250° C./3 h+1180° C./4 h+1120° C./2.5 h+850° C./24 h (FIG. 6)
Third sample: 1250° C./1 h (FIG. 7)
Fourth sample: 1260° C./1 h (FIG. 8)

For comparison, a further sample was subjected to a reference heat treatment according to FIG. 3 with heat treatment steps B1-B3 specified as

B1 HIP(1180° C./4 h)
B2 1120° C./2.5 h
B3 850° C./24 h.

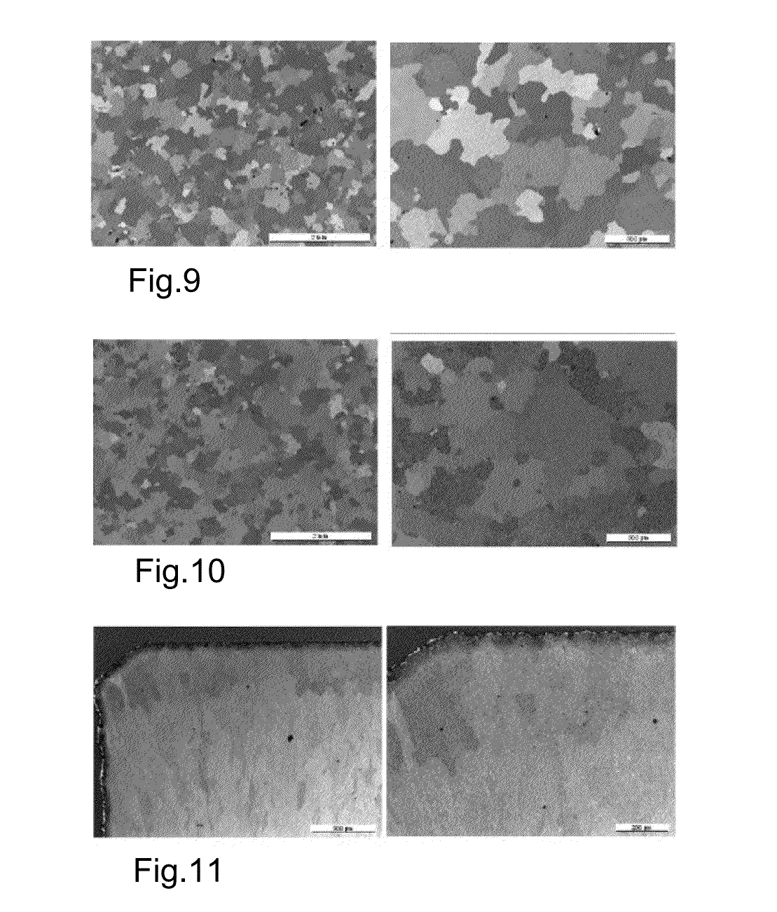

The resulting microstructure of the samples 1 and 2 being solution heat-treated at 1250° C./3 h (FIG. 5, 6) is shown in the pictures of FIGS. 9 and 10. As can be seen from FIG. 13, significant grain coarsening took place (lower left and right picture) in comparison to the reference heat treatment (upper left and right picture).

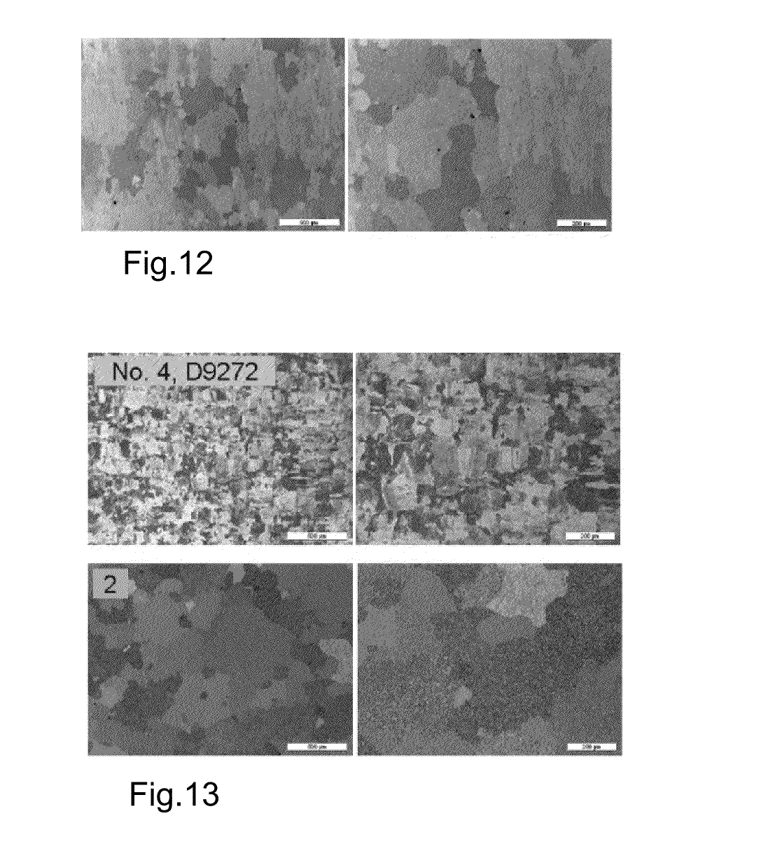

However, the hold-time of 1 h at 1250° C. and 1260° C. according to FIGS. 7 and 8, respectively, is not yet sufficient to achieve a fully re-crystallized/coarsened microstructure (see FIGS. 11 and 12).

Furthermore, it is important to note that the γ′ (gamma prime) precipitate size and morphology strongly depends on the cooling rates.

Grain boundary morphology and precipitates are important for good creep properties. Therefore, a conventionally cast IN738LC microstructure has been analyzed as well. As a result, carbide precipitates are found along the grain boundaries. In IN738LC mainly two types of carbides are present, the Ti(Ta, Nb)-rich MC type carbides, and the M₂₃C₆ carbides, especially rich in chromium.

In the “as-built” condition, carbide precipitates on the μm-scale were not found in material produced by selective laser melting (SLM). It is important to note that apart from the hardening γ′ phase also minor fractions of MC and M₂₃C₆ carbides and also M₃B₂ borides are additional hardening precipitates, and are especially important for grain boundary strengthening.

In conclusion, the results show that grain coarsening of IN738LC produced by selective laser melting (“as-built” condition) can be achieved by a full solution heat treatment above the γ′-solvus temperature, e.g. for 3 h at 1250° C.

The basic idea is to perform the heat treatment above the γ′-solvus temperature. Due to the fact that the SLM material is very homogeneous (see Electron Microprobe Analysis (FIG. 1), the risk of incipient melting is reduced. Pronounced compositional inhomogeneity as observed in cast components/coupons, e.g. micro-segregations due to the dendritic solidification, are not found in components/coupons produced by SLM so far.

Thus, Ni- and/or Co-based superalloys produced by SLM have the potential to be heat-treated at higher temperatures compared to conventionally cast material of the same composition. This is primarily due to powder based article production and the inherent high cooling rates of the energy beam-material interaction in the SLM process. The homogeneous composition of the SLM material, principally free of segregations, has been shown by Electron Microprobe Analysis (EPMA).

In order to achieve optimized microstructures with respect to grain size and grain boundary/(γ/γ′) morphology, special heat treatments are used to obtain tailored material properties.

As has been explained with regard to FIG. 5-8 the heat treatment according to the invention can be a combination of different individual heat treatments (e.g. A, B1, B2, B3). Thus, said heat treatment may consist of multiple steps, each representing a specific combination of heating rate, hold temperature, hold time and cooling rate.

The heat treatment can be done in the manufacturing equipment or by means of independent equipment. The component or coupon to be manufactured can be subjected to said heat treatment either as a whole or only partially.

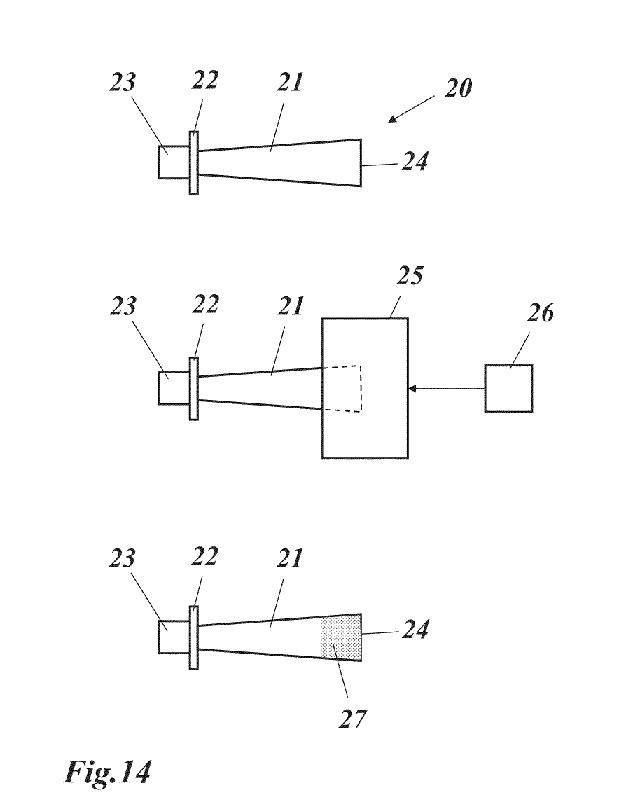

FIG. 14 shows process steps of a partial heat treatment according to the invention to modify the properties of a component (in this example a turbine blade) in a specified region of said component. The turbine blade 20 of FIG. 14 comprises an airfoil 21, a platform 22 and blade root 23. To optimize the mechanical behavior of e.g. a blade tip region, the blade 20 is introduced with this blade tip region into the interior of heat treatment device 25, which may be an oven. By means of suitable control 26 the temperature within the heat treatment device 25 is controlled in accordance with a heat treatment curve, as shown for example in FIG. 5-8. When the heat treatment has been done, the blade 20 has optimized properties in the region 27 of the blade tip.

In another example a coupon is manufactured by SLM and then heat treated according to the disclosure. This coupon is used for repairing a turbine blade by inserting it into the blade to be repaired followed by a heat treatment of the composed blade.

### LIST OF REFERENCE NUMERALS

20 turbine blade
21 airfoil
22 platform
23 root
24 tip
25 heat treatment device (e.g. oven)
26 control
27 optimized region

What is claimed is:

1. A method for manufacturing a component or coupon made of a high temperature superalloy based on Ni, Co, Fe or combinations thereof, the method comprising:
a) forming the component or coupon using a powder-based additive manufacturing process, the manufacturing process including completely melting the powder followed by solidifying the powder; and
b) subjecting the formed component or coupon to a heat treatment so as to optimize specific material properties;
wherein
c) the heat treatment takes place at higher temperatures compared to cast components or coupons.

2. The method according to claim 1, wherein the powder-based additive manufacturing process is one of Selective Laser Melting (SLM), Selective Laser Sintering (SLS) or Electron Beam Melting (EBM) and includes:
a) generating a three-dimensional model of the component or coupon;
b) calculating cross sections of the model using a slicing process;
c) providing an additive manufacturing machine with a machine control unit;
d) preparing the powders of the superalloy that are needed for the process,
e) passing the calculated cross sections to the machine control unit and storing the calculated cross sections in the machine control unit;
f) preparing a powder layer with a regular and uniform thickness on a substrate plate of the additive manufacturing machine or on a previously processed powder layer;
g) performing melting of the powder layer by scanning with an energy beam according to a cross section of the component or coupon stored in the control unit;
h) lowering the upper surface of the formed cross section by one layer thickness; and
i) repeating steps f) to h) until reaching the last cross section of said three-dimensional model.

3. The method according to claim 2, wherein a particle size distribution of the powder is adjusted to the layer thickness to achieve a good flowability so as to prepare powder layers with regular and uniform thickness.

4. The method according to claim 2, wherein the powder consists of grains having a spherical shape.

5. The method according to claim 3, wherein the particle size distribution of the powder is obtained by at least one of sieving or winnowing (air separation).

6. The method according to claims 2, wherein the powder or powders are obtained by one of gas or water atomization, plasma-rotating-electrode process, mechanical milling or like powder-metallurgical processes.

7. The method according to claim 1, wherein the powder-based additive manufacturing process is one of Laser Metal Forming (LMF), Laser Engineered Net Shape (LENS) or Direct Metal Deposition (DMD).

8. The method according to claim 1, wherein a suspension is used instead of powder.

9. The method according to claim 1, wherein the superalloy comprises fine dispersed oxides, especially Y₂O₃, AlO₃ or ThO₂.

10. The method according to claim 1, wherein the heat treatment is done in an equipment, which is used for forming the component or coupon.

11. The method according to claim 1, wherein the heat treatment is done in an equipment, which is different from a component or coupon forming equipment.

12. The method according to claim 1, wherein the heat treatment is a combination of different individual heat treatments.

13. The method according to claim 1, wherein only part of the component or coupon is subjected to the heat treatment.

14. The method according to claim 1, wherein the heat treatment comprises multiple steps, each step representing a specific combination of heating rate, hold temperature, hold time and cooling rate.

15. The method according to claim 14, wherein at least one of before or after each heat treatment step the component or coupon is subjected to various other processing steps such as, but not limited to, machining, welding or brazing, to use the specific advantages of a specific microstructure, e.g. small grains, which are beneficial for welding.

16. The method according to claim 14, wherein at least one of the heat treatment steps is conducted at a sufficient high temperature and for a hold time long enough to partially or completely dissolve certain constituents in a microstructure of the component or coupon, such as intermetallic phases, carbides or nitrides.

17. The method according to claim 14, wherein at least one of the heat treatment steps is conducted at a sufficient high temperature and for a hold time long enough to coarsen grains being present within the component or coupon.

18. The method according to claim 17, wherein prior to the grain coarsening, the component or coupon is deformed or specifically positioned in a powder bed and scanned with a specific hatching strategy to introduce residual stresses leading to anisotropic grain elongation in the corresponding heat treatment step.

19. The method according to claim 14, wherein at least one of the heat treatment steps is conducted at a sufficient high temperature and for a hold time long enough to precipitate metal-carbides, metal-nitrides or metal-carbonitrides, such as but not limited to, M(C,N), M₆C, M₇C₃ or M₂₃C₆ (M being a metal).

20. The method according to claim 14, wherein at least one of the heat treatment steps is conducted at a sufficient high temperature and for a hold time long enough to precipitate intermetallic phases such as, but not limited to, Ni₃(Al,Ti), known as gamma-prime, or Ni₃(Nb,Al,Ti), known as gamma-double-prime, or Ni₃Nb, known as delta-phase.

21. The method according to claim 14, wherein at least one of the heat treatment steps is conducted at a sufficient high temperature and for a hold time long enough to precipitate metal-borides such as, but not limited to, M₃B₂, (M being a metal), to improve grain boundary strength.

22. The method according to claim 19, wherein at least one of the heat treatment steps is conducted at a sufficient high temperature and for a hold time long enough to modify the volume fraction, size, shape and distribution of the precipitations.

23. The method according to claim 14, wherein at least one of the heat treatment steps is conducted additionally under isostatic pressure, known as hot Isostatic pressing (HIP), to further improve a microstructure of the component or coupon.
